(19) United States
(12) Patent Application Publication
(10) Pub. No.: US 2026/0267420 A1
(43) Pub. Date: Sep. 10, 2026

(54) AUGMENTED AND VIRTUAL REALITY OBJECT-AWARE HAND TRACKING

(71) Applicant: Snap Inc., Santa Monica, CA (US)

(72) Inventors: Ilteris Kaan Canberk, Los Angeles, CA (US); Georgios Evangelidis, Vienna (AT); Su Hyun Lee, San Jose, CA (US); Daniel Wolf, Mödling (AT)

(21) Appl. No.: 19/192,003

(22) Filed: Apr. 28, 2025

(30) Foreign Application Priority Data
Mar. 4, 2025 (GR) 20250100160

(51) Int. Cl. G06F 3/01; G06V 10/70; G06V 40/20

(52) U.S. Cl. CPC G06F 3/017; G06F 3/011; G06V 10/70; G06V 40/28

(57) ABSTRACT

A head-worn device system includes one or more cameras, one or more display devices and one or more processors. The system also includes a memory storing instructions that, when executed by the one or more processors, configure the system to receive image data from one or more cameras of an augmented reality device, and detect a hand of a user within the image data. Based on the system determining that the hand is holding the object, the system sets an object-in-hand detection flag and can enable or disable at least one user interface element corresponding the hand that is holding the object.

### CLAIM OF PRIORITY

This application claims the benefit of priority to Greece Patent Application Serial No. 20250100160, filed on Mar. 4, 2025, which is incorporated herein by reference in its entirety.

### TECHNICAL FIELD

The present disclosure relates generally to display devices, and more particularly, to display devices used for augmented and virtual reality.

### BACKGROUND

A head-worn device can be implemented with a transparent or semi-transparent display through which a user of the head-worn device can view the surrounding environment. Such devices enable a user to see through the transparent or semi-transparent display to view the surrounding environment, and to also see objects (e.g., virtual objects such as 3D renderings, images, video, text, and so forth) that are generated for display to appear as a part of, and/or overlaid upon, the surrounding environment. This is typically referred to as “augmented reality” or “AR.” A head-worn device may additionally completely occlude a user's visual field and display a virtual environment through which a user may move or be moved. This is typically referred to as “virtual reality” or “VR.” Collectively, AR and VR as known as extended reality or “XR.” As used herein, the term XR refers to either or both augmented reality and virtual reality as traditionally understood, unless the context indicates otherwise.

A user of the head-worn device may access and use a computer software application to perform various tasks or engage in an entertaining activity. To use the computer software application, the user interacts with a 3D user interface provided by the head-worn device.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a perspective view of a head-worn device, in accordance with some examples.

FIG. 2 illustrates a further view of the head-worn device of FIG. 1, in accordance with some examples.

FIG. 3 is a block diagram illustrating a networked system 300 including details of the head-worn device of FIG. 1, in accordance with some examples.

FIG. 4 is a flow chart illustrating operations of a method, in accordance with some examples.

FIGS. 5-6 illustrate example user interfaces, in accordance with some examples.

FIG. 7 depicts a sequence diagram of an example user interface process, in accordance with some examples.

FIG. 8 is a diagrammatic representation of a networked environment in which the present disclosure may be deployed, in accordance with some examples.

FIG. 9 is a block diagram showing a software architecture within which the present disclosure may be implemented, in accordance with some examples.

FIG. 10 is a diagrammatic representation of a machine, in the form of a computer system within which a set of instructions can be executed for causing the machine to perform any one or more of the methodologies discussed herein in accordance with some examples.

### DETAILED DESCRIPTION

In some examples, a user's interaction with software applications executing on an XR device is achieved via a user interface that includes virtual objects displayed to a user by the XR device. In the case of AR, the user perceives the virtual objects as objects within an overlay in the user's field of view of the real world while wearing the XR device. In the case of VR, the user perceives the virtual objects as objects within the virtual world as viewed by the user while wearing the XR device. To allow the user to interact with the virtual objects, the XR device detects the user's hand positions and movements and uses those hand positions and movements to determine the user's intentions in manipulating the virtual objects. A user holding an object in their hand, however, such as a mobile device, can interfere with the ability of the XR device to effectively track hand positions and movements to determine the user's intent. For example, a hand tracking system may not be able to reliably distinguish between intentional and unintentional hand movements when a user is holding an object, particularity when holding a phone or other mobile device. This can result in accidental user interface triggers as the system continues tracking hand movements and displaying user interface elements even when a user is just holding a phone to use it normally.

Further, hand tracking performance can be degraded when a phone or other object occludes parts of the user's hand. For example, a hand tracking system typically tracks multiple joints in a hand (e.g., 21 joints) to enable precise hand gesture recognition, but when the phone or other object partially blocks the hand from one or more camera view, it can cause erratic movements and unreliable hand tracking.

To solve these technical problems, an XR object-aware hand tracking system is described herein that detects if there is an object in a hand of a user of an XR device and if so, flags the fact of the object in hand to trigger certain functionality of the XR device to be enabled or disabled. This prevents accidental triggers while maintaining functionality in the hand that is not holding any object. For example, a machine learning model is specifically trained to detect objects (e.g., phone-like objects) held in a user's hand. When an object is detected in a hand by the machine learning model, the XR object-aware hand tracking system automatically disables user interface elements like a cursor associated with the hand holding the object, automatically enables other user interface elements like a cursor associated with a mobile device held in the hand, or automatically enables or disables other features. For example, the XR object-aware tracking system automatically transitions from hand-based cursor control to device-based cursor control, enabling seamless switching between hand gestures and device-based input methods. The XR object-aware tracking system can also intelligently disable virtual button displays on a hand holding an object to reduce user confusion and improve interface clarity. A user can hold and use physical objects while maintaining reliable control of virtual interfaces with their free hand, as the XR object-aware tracking system prevents accidental triggers while preserving functionality in the non-object holding hand.

In some examples, the XR object-aware hand tracking system can receive image data from one or more cameras of an augmented reality device and detect a hand of a user within the image data. Based on the system determining that the hand is holding the object, the system sets an object-in-hand detection flag and can enable or disable at least one user interface element corresponding the hand that is holding the object.

Other technical features may be readily apparent to one skilled in the art from the following figures, descriptions, and claims.

### XR Device

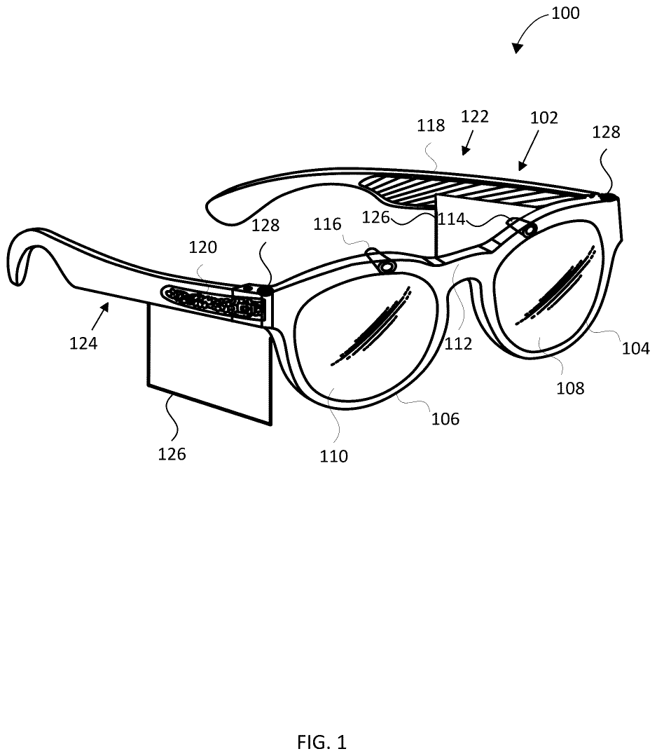

FIG. 1 is perspective view of a head-worn XR device (e.g., glasses 100), in accordance with some examples. The glasses 100 can include a frame 102 made from any suitable material such as plastic or metal, including any suitable shape memory alloy. In one or more examples, the frame 102 includes a first or left optical element holder 104 (e.g., a display or lens holder) and a second or right optical element holder 106 connected by a bridge 112. A first or left optical element 108 and a second or right optical element 110 can be provided within respective left optical element holder 104 and right optical element holder 106. The right optical element 110 and the left optical element 108 can be a lens, a display, a display assembly, or a combination of the foregoing. Any suitable display assembly can be provided in the glasses 100.

The frame 102 additionally includes a left arm or temple piece 122 and a right arm or temple piece 124. In some examples the frame 102 can be formed from a single piece of material so as to have a unitary or integral construction.

The glasses 100 can include a computing device, such as a computer 120, which can be of any suitable type so as to be carried by the frame 102 and, in one or more examples, of a suitable size and shape, so as to be partially disposed in one of the temple piece 122 or the temple piece 124. The computer 120 can include one or more processors with memory, wireless communication circuitry, and a power source. As discussed below, the computer 120 comprises low-power circuitry, high-speed circuitry, and a display processor. Various other examples may include these elements in different configurations or integrated together in different ways. Additional details of aspects of computer 120 may be implemented as illustrated by the data processor 302 discussed below.

The computer 120 additionally includes a battery 118 or other suitable portable power supply. In some examples, the battery 118 is disposed in left temple piece 122 and is electrically coupled to the computer 120 disposed in the right temple piece 124. The glasses 100 can include a connector or port (not shown) suitable for charging the battery 118, a wireless receiver, transmitter or transceiver (not shown), or a combination of such devices.

The glasses 100 include a first or left camera 114 and a second or right camera 116. Although two cameras are depicted, other examples contemplate the use of a single or additional (i.e., more than two) cameras. In one or more examples, the glasses 100 include any number of input sensors or other input/output devices in addition to the left camera 114 and the right camera 116. Such sensors or input/output devices can additionally include biometric sensors, location sensors, motion sensors, and so forth.

In some examples, the left camera 114 and the right camera 116 provide video frame data (e.g., image data) for use by the glasses 100 to extract 3D information from a real-world scene.

The glasses 100 can also include a touchpad 126 mounted to or integrated with one or both of the left temple piece 122 and right temple piece 124. The touchpad 126 is generally vertically-arranged, approximately parallel to a user's temple in some examples. As used herein, generally vertically aligned means that the touchpad is more vertical than horizontal, although potentially more vertical than that. Additional user input can be provided by one or more buttons 128, which in the illustrated examples are provided on the outer upper edges of the left optical element holder 104 and right optical element holder 106. The one or more touchpads 126 and buttons 128 provide a means whereby the glasses 100 can receive input from a user of the glasses 100.

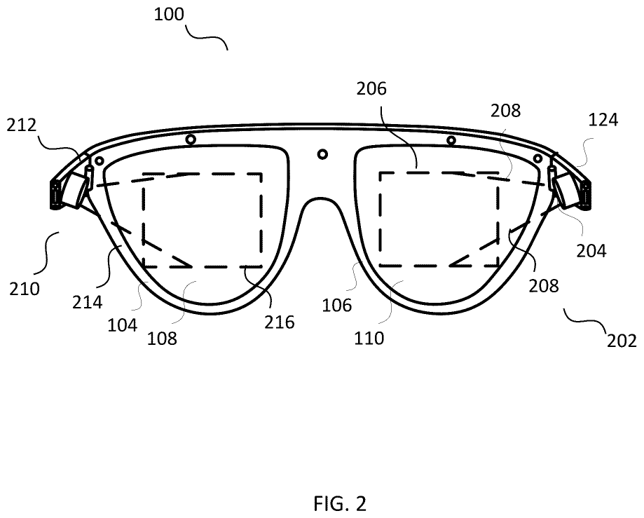

FIG. 2 illustrates the glasses 100 from the perspective of a user. For clarity, a number of the elements shown in FIG. 1 have been omitted. As described in FIG. 1, the glasses 100 shown in FIG. 2 include left optical element 108 and right optical element 110 secured within the left optical element holder 104 and the right optical element holder 106 respectively.

The glasses 100 include forward optical assembly 202 comprising a right projector 204 and a right near eye display 206, and a forward optical assembly 210 including a left projector 212 and a left near eye display 216.

In some examples, the near eye displays are waveguides. The waveguides include reflective or diffractive structures (e.g., gratings and/or optical elements such as mirrors, lenses, or prisms). Light 208 emitted by the projector 204 encounters the diffractive structures of the waveguide of the near eye display 206, which directs the light towards the right eye of a user to provide an image on or in the right optical element 110 that overlays the view of the real world seen by the user. Similarly, light 214 emitted by the projector 212 encounters the diffractive structures of the waveguide of the near eye display 216, which directs the light towards the left eye of a user to provide an image on or in the left optical element 108 that overlays the view of the real world seen by the user. The combination of a GPU, the forward optical assembly 202, the left optical element 108, and the right optical element 110 provide an optical engine of the glasses 100. The glasses 100 use the optical engine to generate an overlay of the real-world view of the user including display of a 3D user interface to the user of the glasses 100.

It will be appreciated however that other display technologies or configurations may be utilized within an optical engine to display an image to a user in the user's field of view. For example, instead of a projector 204 and a waveguide, an LCD, LED or other display panel or surface can be provided.

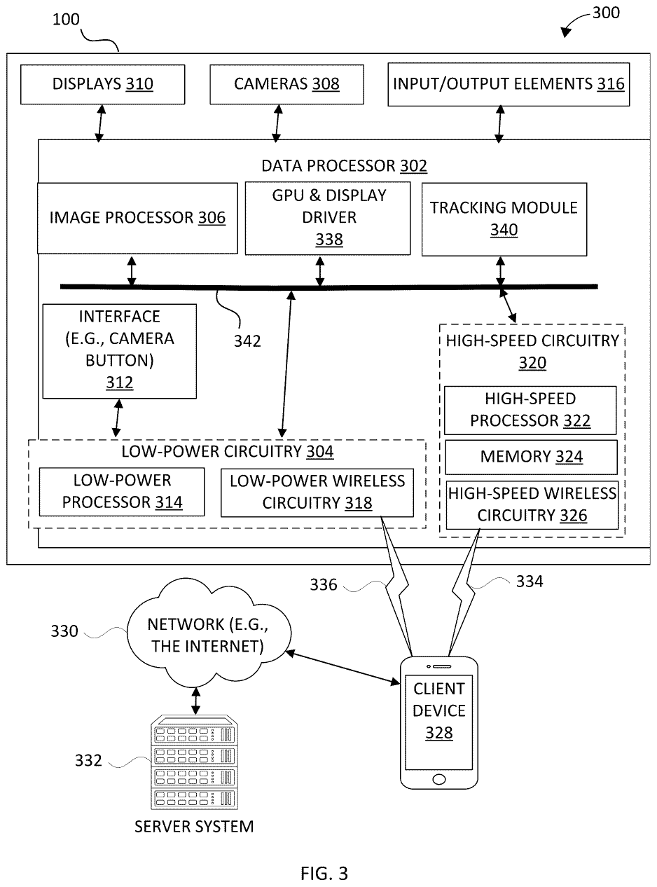

In use, a user of the glasses 100 will be presented with information, content and various user interfaces, such as 3D user interfaces, on the near eye displays. As described in more detail herein, the user can then interact with the glasses 100 using a touchpad 126 and/or the buttons 128, voice inputs or touch inputs on an associated device (e.g. client device 328 illustrated in FIG. 3), and/or hand movements, locations, and positions detected by the glasses 100.

### Networked System

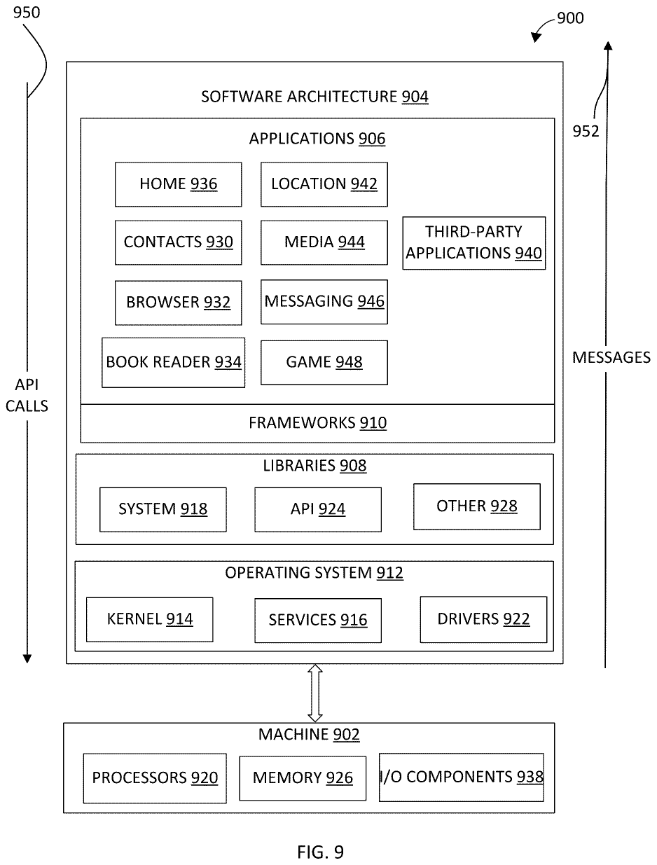

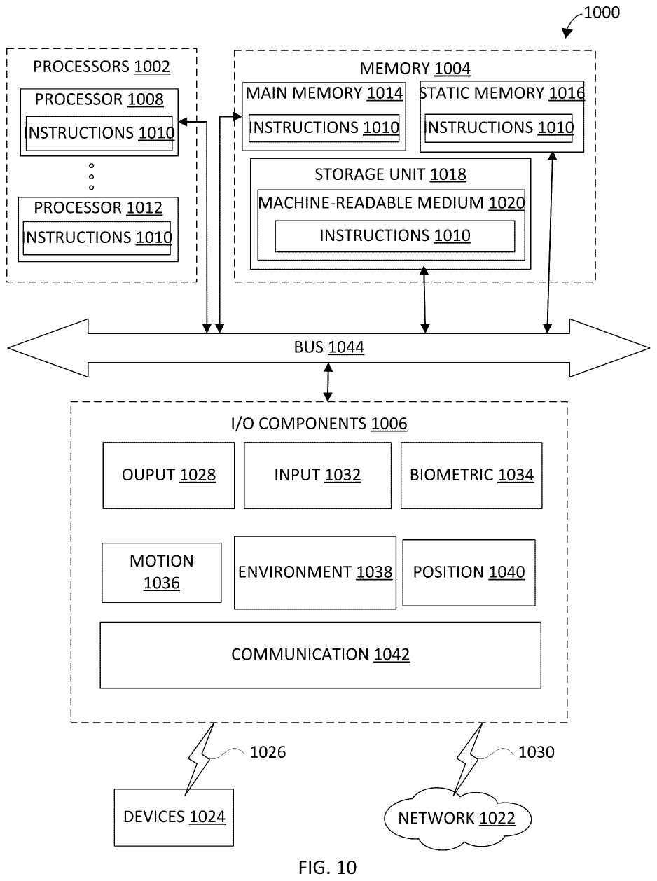

FIG. 3 is a block diagram illustrating a networked system 300 including details of the glasses 100, in accordance with some examples. The networked system 300 includes the glasses 100, a client device 328, and a server system 332. The client device 328 may be a smartphone, tablet, phablet, laptop computer, access point, mobile device or any other such computing device capable of connecting with the glasses 100 using a low-power wireless connection 336 and/or a high-speed wireless connection 334. The client device 328 is connected to the server system 332 via the network 330. The network 330 can include any combination of wired and wireless connections. The server system 332 can be one or more computing devices as part of a service or network computing system. The client device 328 and any elements of the server system 332 and network 330 can be implemented using details of the software architecture 504 or the machine 700 described in FIG. 9 and FIG. 10 respectively.

The glasses 100 include a data processor 302, displays 310, one or more cameras 308, and additional input/output elements 316. The input/output elements 316 can include microphones, audio speakers, biometric sensors, additional sensors, or additional display elements integrated with the data processor 302. Examples of the input/output elements 316 are discussed further with respect to FIG. 9 and FIG. 10. For example, the input/output elements 316 can include any of I/O components 706 including output components 728, motion components 736, and so forth. Examples of the displays 310 are discussed in FIG. 2. In the particular examples described herein, the displays 310 include a display for the user's left and right eyes.

The data processor 302 includes an image processor 306 (e.g., a video processor), a GPU & display driver 338, a tracking module 340, an interface 312, low-power circuitry 304, and high-speed circuitry 320. The components of the data processor 302 are interconnected by a bus 342.

The interface 312 refers to any source of a user command that is provided to the data processor 302. In one or more examples, the interface 312 is a physical button that, when depressed, sends a user input signal from the interface 312 to a low-power processor 314. A depression of such button followed by an immediate release can be processed by the low-power processor 314 as a request to capture a single image, or vice versa. A depression of such a button for a first period of time can be processed by the low-power processor 314 as a request to capture video data while the button is depressed, and to cease video capture when the button is released, with the video captured while the button was depressed stored as a single video file. Alternatively, depression of a button for an extended period of time can capture a still image. In some examples, the interface 312 can be any mechanical switch or physical interface capable of accepting user inputs associated with a request for data from the cameras 308. In other examples, the interface 312 can have a software component, or can be associated with a command received wirelessly from another source, such as from the client device 328.

The image processor 306 includes circuitry to receive signals from the cameras 308 and process those signals from the cameras 308 into a format suitable for storage in the memory 324 or for transmission to the client device 328. In one or more examples, the image processor 306 (e.g., video processor) comprises a microprocessor integrated circuit (IC) customized for processing sensor data from the cameras 308, along with volatile memory used by the microprocessor in operation.

The low-power circuitry 304 includes the low-power processor 314 and the low-power wireless circuitry 318. These elements of the low-power circuitry 304 may be implemented as separate elements or may be implemented on a single IC as part of a system on a single chip. The low-power processor 314 includes logic for managing the other elements of the glasses 100. As described above, for example, the low-power processor 314 may accept user input signals from the interface 312. The low-power processor 314 may also be configured to receive input signals or instruction communications from the client device 328 via the low-power wireless connection 336. The low-power wireless circuitry 318 includes circuit elements for implementing a low-power wireless communication system. Bluetooth™ Smart, also known as Bluetooth™ low energy, is one standard implementation of a low power wireless communication system that may be used to implement the low-power wireless circuitry 318. In other examples, other low power communication systems may be used.

The high-speed circuitry 320 includes a high-speed processor 322, a memory 324, and a high-speed wireless circuitry 326. The high-speed processor 322 may be any processor capable of managing high-speed communications and operation of any general computing system used for the data processor 302. The high-speed processor 322 includes processing resources used for managing high-speed data transfers on the high-speed wireless connection 334 using the high-speed wireless circuitry 326. In some examples, the high-speed processor 322 executes an operating system such as a LINUX operating system or other such operating system such as the operating system 912 of FIG. 9. In addition to any other responsibilities, the high-speed processor 322 executing a software architecture for the data processor 302 is used to manage data transfers with the high-speed wireless circuitry 326. In some examples, the high-speed wireless circuitry 326 is configured to implement Institute of Electrical and Electronic Engineers (IEEE) 802.11 communication standards, also referred to herein as Wi-Fi. In other examples, other high-speed communications standards may be implemented by the high-speed wireless circuitry 326.

The memory 324 includes any storage device capable of storing camera data generated by the cameras 308 and the image processor 306. While the memory 324 is shown as integrated with the high-speed circuitry 320, in other examples, the memory 324 may be an independent standalone element of the data processor 302. In some such examples, electrical routing lines may provide a connection through a chip that includes the high-speed processor 322 from image processor 306 or the low-power processor 314 to the memory 324. In other examples, the high-speed processor 322 can manage addressing of the memory 324 such that the low-power processor 314 will boot the high-speed processor 322 any time that a read or write operation involving the memory 324 is desired.

The tracking module 340 estimates a pose of the glasses 100. For example, the tracking module 340 uses image data and corresponding inertial data from the cameras 308 and the position components 740, as well as GPS data, to track a location and determine a pose of the glasses 100 relative to a frame of reference (e.g., real-world environment). The tracking module 340 continually gathers and uses updated sensor data describing movements of the glasses 100 to determine updated three-dimensional poses of the glasses 100 that indicate changes in the relative position and orientation relative to physical objects in the real-world environment. The tracking module 340 permits visual placement of virtual objects relative to physical objects by the glasses 100 within the field of view of the user via the displays 310.

The GPU & display driver 338 can use the pose of the glasses 100 to generate frames of virtual content or other content to be presented on the displays 310 when the glasses 100 are functioning in a traditional augmented reality mode. In this mode, the GPU & display driver 338 generates updated frames of virtual content based on updated three-dimensional poses of the glasses 100, which reflect changes in the position and orientation of the user in relation to physical objects in the user's real-world environment.

One or more functions or operations described herein can also be performed in an Application resident on the glasses 100 or on the client device 328, or on a remote server. For example, one or more functions or operations described herein can be performed by one of the applications 506 such as messaging application 546.

### XR Object-Aware Hand Tracking System

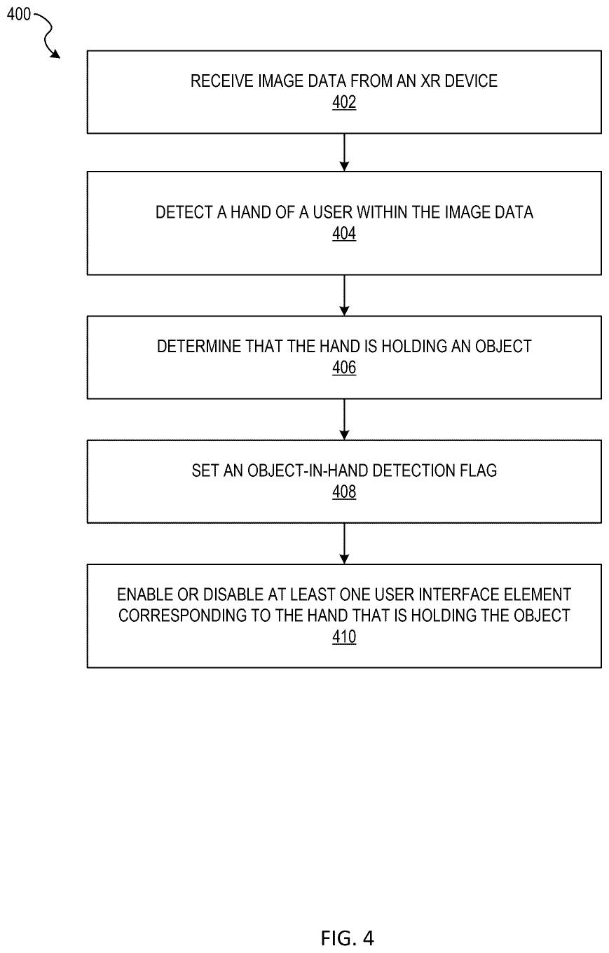

FIG. 4 is a flow chart illustrating aspects of a method 400 for operation of an XR object-aware hand tracking system, according to some example embodiments. For illustrative purposes, the method 400 is described with respect to FIG. 3. It is to be understood that the method 400 may be practiced with other system configurations in other embodiments.

In operation 402, a computing system (e.g., head wearable device such as glasses 100, server system 332, client device 328) receives image data from one or more cameras of an XR device. For instance, an XR device can comprise one or more cameras that can each be active at any given time. The computing system receives image data in real time, or near real time, as it is being generated by the one or more cameras. In some examples, the image data comprises a plurality of image or video frames.

In operation 404, the computing system detects a hand of the user within the image data. For example, the computing system analyzes the image data using a computer vision model trained to detect a hand of a user, to determine that there is a hand of a user in the image data, such as in one or more frames of image data received from the one or more cameras of the XR device. Some examples of a computer vision model that can be used to detect the hand of a user within image data include convolutional neural networks (CNNs) and other computer vision models, such as Mediapipe.

In operation 406, the computing system determines that the detected hand is holding an object. An object can be a phone, a mug, a pen or pencil, a water bottle, or other object. For example, the computing system, using a machine learning model or other method for object detection, determines that a hand is holding an object. In some examples, the computing system can determine that the hand is in a particular pose (e.g., position/orientation) to determine that the hand is holding an object.

The computing system analyzes the image data over multiple frames to detect that an object is held by the hand (detected in operation 404) for at least a threshold period of time. For instance, to be sure that the hand is indeed holding an object, the computing system observes several frames of the received image data over a period of time to confirm that the hand is holding an object. For example, the computing system can detect that a hand is holding an object for a predefined number of frames (e.g., 10, 12) and/or for a predefined period of time (e.g., 0.5, 0.7 seconds). In some examples, the object is a phone-like object, such as a mobile device.

The machine learning model is trained using a comprehensive dataset collected from multiple XR devices in real-world usage scenarios. In some examples, the training data comprises two key components: image data showing hands in various states and corresponding hand-tracking data that is temporally synchronized with the images.

The image dataset includes a diverse range of examples capturing hands holding objects and hands without objects across different environmental conditions. For example, the computing system collects image data from one or more cameras of each of a plurality of XR devices that includes one or more hand holding a phone or other object in various positions. For example, the computing system collects images of a hand holding an object in various lighting conditions, in various environments, with various hand sizes, with various types of object and colors of objects, and so forth. In some examples, machine learning model is trained to detect a mobile device-like object (e.g., a phone-like object) and the collected images comprise images of hands holding various phone models and colors.

In some examples, the computing system collects images showing variations in lighting conditions, environmental contexts, hand sizes and positions, object types and colors, grid patterns and holding positions, and so forth. For phone-like object detection specifically, the training dataset incorporates images of hands holding various phone models with different form factors and colors to ensure robust detection across device types.

The ground truth labeling process leverages the XR device's hand-tracking data to automatically generate labels for the training images. By synchronizing the hand-tracking data with the corresponding image frames, the computing system can efficiently label each image to indicate whether a hand is holding an object or not. This automated labeling approach enables efficient generation of large-scale training datasets while maintaining accuracy in the ground truth data.

In operation 408, the computing system, sets a flag based on determining that the hand is holding the object. For example, the computing system sets an object-in-hand detection flag to TRUE to indicate that it has detected a hand holding an object.

In operation 410, the computing system adjusts intractability of at least one user interface element corresponding the hand that is holding the object, such as by enabling or disabling the at least one user interface element corresponding the hand that is holding the object (e.g., based on detecting that the object-in-hand detection flag is sent to TRUE). The one or more user interface elements can be a cursor, virtual button, AR or VR experience, or another feature or functionality.

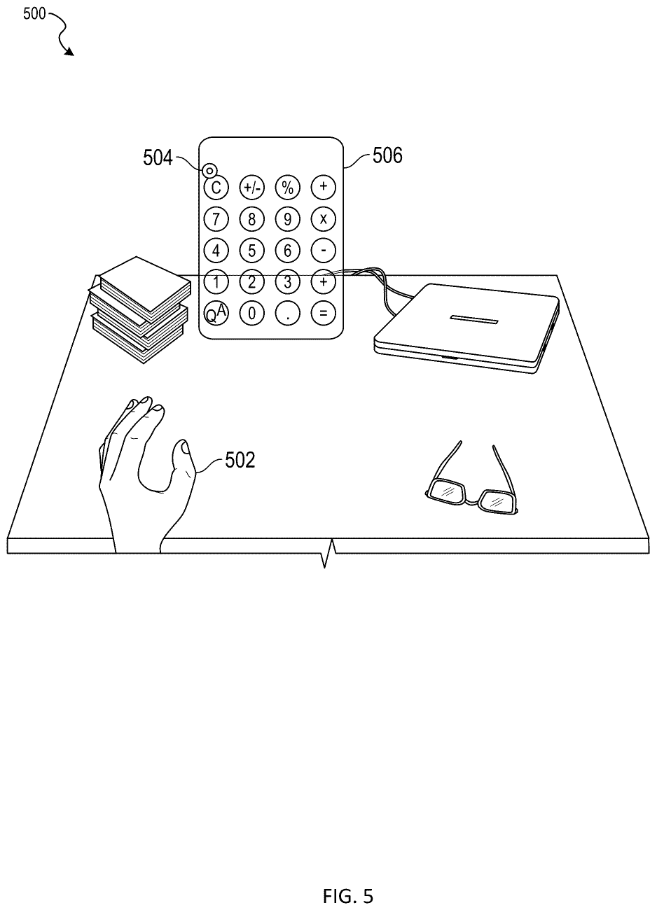

Once example interface element is a cursor, such as a pointer or other indicator. For example, the XR device may display, in a user interface of the XR device, a cursor that is associated (e.g., linked) with the hand. FIG. 5 illustrates an example user interface 500 as viewed by a user wearing a head-wearable XR device (e.g., AR glasses). In FIG. 5 a hand 502 is controlling a cursor 504 in the user interface 500. A virtual keypad 506 is provided in the display overlaid on the real-world environment. In this example, the real-world environment includes a desk and items on a desk. The user can move the hand 502 to control the cursor. For example, when the user moves the hand 502, the cursor 504 moves as the hand 502 moves (e.g., to the left, if the hand moves the left). In this way, the user can move the hand 502 to position the cursor 504 where desired, such as to select a number in the virtual key pad 506.

The cursor allows a user to move the hand to control the cursor to point to and select various user interface elements within the display of the XR device. For instance, the user can move the hand to select one or more menu items for features to enable via the display of the XR device. When the computing system detects that the hand is holding an object, the cursor corresponding to the hand is disabled to avoid any unexpected or unintentional movement or selection by using the cursor. In this way, the computing system can infer that an intent of the user is not to use a hand holding an object to interact with the display of the XR device. If there is another hand detected in the display of the XR device that is not holding an object, the cursor corresponding to the hand that is not holding an object would continue to be displayed and controlled by the hand that is not holding an object.

Another example interface element is one or more virtual buttons that can be displayed on the hand. When the computing system detects that the hand is holding an object, the computing system can disable the one or more virtual buttons so that they do not appear on the hand (or on the object held by the hand) to avoid confusion.

The computing system maintains any interface element corresponding to a user's hand that is not holding an object (e.g., the other user's hand). For example, a cursor corresponding to the user's hand that is not holding an object is still displayed and enabled.

In some examples, a computing device such as a mobile device (e.g., smartphone) or other hand-held computing device, can also be used to interact with the display of the XR device. For example, the computing device can be tethered to the XR device, such as via Bluetooth or other wireless connection. The computing system detects that the object held by the hand is a computing device and disables a cursor associated with the hand and automatically enables a cursor associated with the computing device.

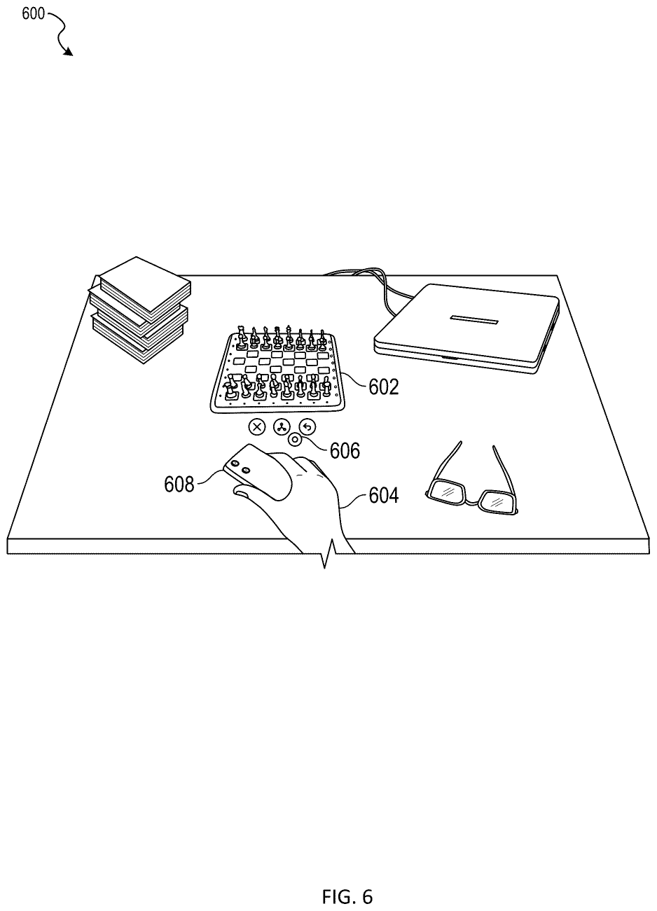

FIG. 6 illustrates an example user interface 600 as viewed by a user wearing a head-wearable XR device (e.g., AR glasses). A virtual chess board 602 is provided in the display overlaid on the real-world environment which includes a desk and items on a desk. The user can move the device 608 (e.g., smartphone) held in the hand 604 to control the cursor 606. For example, when the user moves the device 608, the cursor 606 moves as the device 608 moves (e.g., to the left, if the device 608 moves the left). In this way, the user can move the device 608 to position the cursor 606 where desired, such as to select and move a piece on the virtual chess board 602.

The computing system continues to analyze image data received from the one or more cameras of the XR device to determine if the hand is still holding the object, another hand is holding an object, or the hand is no longer holding the object. For example, the computing system analyzes the image data to determine that the hand is no longer holding the object. In some examples, the computing system observes several frames over a period of time to confirm that the hand is no longer holding an object. For example, the computing system can detect that a hand is no longer holding an object for a predefined number of frames (e.g., 10, 12) or for a predefined period of time (e.g., 0.5, 0.7 seconds).

Based on detecting that the hand is no longer holding an object, the computing system sets the object-in-hand detection flag to FALSE to indicate that it has detected that the hand is no longer holding an object. The computing system re-enables the disabled at least one user interface element corresponding the hand that was previously holding the object or disables the enabled at least one user interface element corresponding the hand that was previously holding the object.

The object-in-hand flag can be accessed by developers such as through an API exposed by the XR device. For example, when the computing system provides the object-in-hand flag through the upper layers of a software stack which developers can then consume to implement various user interface behaviors or general functionality and experiences using via the XR device. For instance, developers can us the object-in-hand flag to gracefully hide or show certain user interface elements to improve the user experience, such as to automatically hide palm user interface elements, disable targeting rays (e.g., for cursors), make hand visual transparent, or the like.

### Hand Tracking System

As indicated above, generation of a user interface for an XR device and detection of the user's interactions with the virtual objects include detection of real world objects (e.g., faces, hands, bodies, cats, dogs, surfaces, objects), tracking of such real world objects as they leave, enter, and move around the field of view in video frames, and the modification or transformation of such real world objects as they are tracked. In various examples, different methods for detecting the real-world objects and achieving such transformations are used. For instance, some examples involve generating a 3D mesh model of a real world object or real world objects, and using transformations and animated textures of the model within the video frames to achieve the transformation. In other examples, tracking of points on a real-world object may be used to place an image or texture, which can be two dimensional or three dimensional, at the tracked position. In still further examples, neural network analysis of video frames may be used to place images, models, or textures in content (e.g., images or frames of video). XR effect data thus can include both the images, models, and textures used to create transformations in content, as well as additional modeling and analysis information used to achieve such transformations with real world object detection, tracking, and placement.

As referred to herein, the phrase “augmented reality experience,” includes or refers to various image processing operations corresponding to an image modification, filter, media overlay, transformation, and the like, as described further herein. In some examples, these image processing operations provide an interactive experience of a real-world environment, where objects, surfaces, backgrounds, lighting and so forth in the real world are enhanced by computer-generated perceptual information. In this context an “augmented reality effect” comprises the collection of data, parameters, and other assets used to apply a selected augmented reality experience to an image or a video feed.

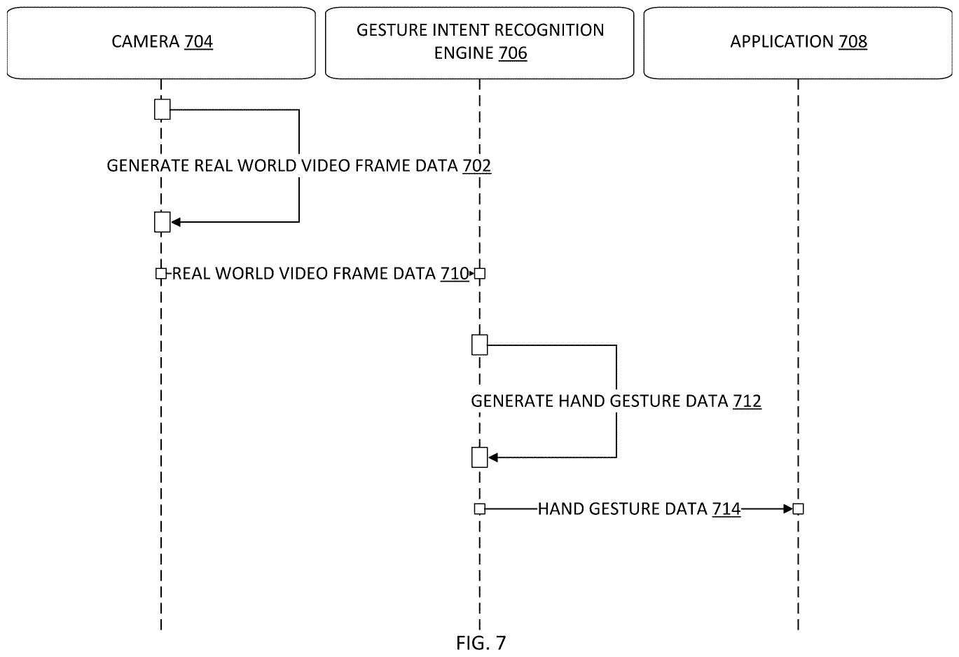

FIG. 7 depicts a sequence diagram of an example user interface process in accordance with some examples. One or more cameras 704 of an XR device (e.g., glasses 100) generate 702 real world video frame data 710 (e.g., image data) of a real world as viewed by a user of the XR device. Included in the real-world video frame data 710 is hand position video frame data of one or more of the user's hands from a viewpoint of the user while wearing the XR device and viewing the real world through the XR device. Thus, the real-world video frame data 710 include hand location video frame data and hand position video frame data of the user's hands as the user makes movements with their hands. The gesture intent recognition engine 706 utilizes the hand location video frame data and hand position video frame data in the real-world video frame data 710 to generate 712 hand gesture data including hand gesture categorization information indicating one or more hand gestures being made by the user. The gesture intent recognition engine 706 communicates the hand gesture data 714 to an application 708 that utilized the hand gesture data 714 as an input from a user interface.

In some examples, the application 708 performs the functions of the gesture intent recognition engine 706 by utilizing various APIs and system libraries to receive and process the real-world video frame data 710 from the one or more cameras 704 to determine the hand gesture data 714.

### Networked Messaging System

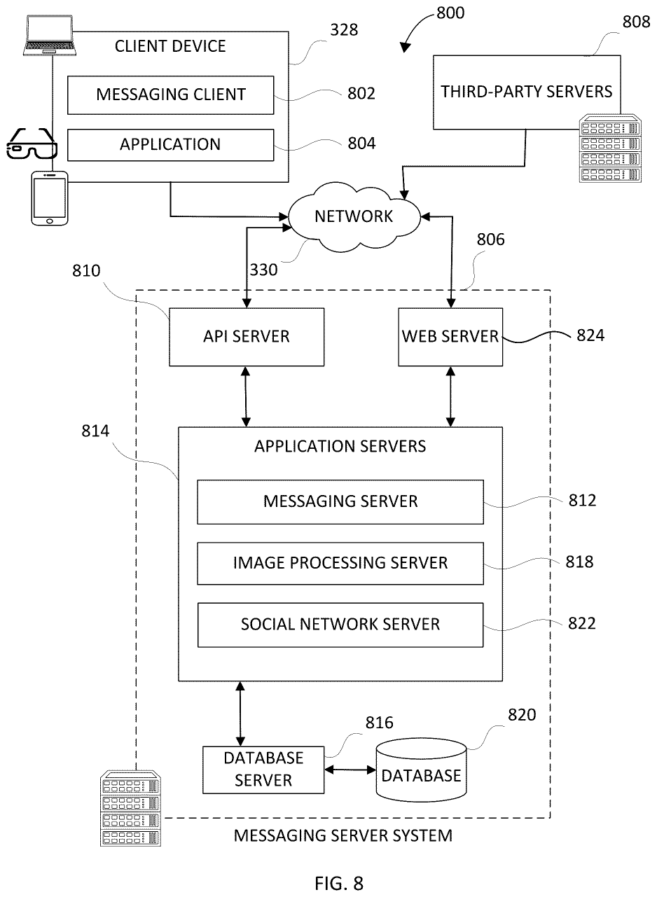

In some examples, an XR device or another computing device coupled with an XR device, is used to generate and exchanges messages with other computing devices, such as to exchange messages comprising one or more of images, video, text and audio. FIG. 8 is a block diagram showing an example messaging system 800 for exchanging data (e.g., messages and associated content) over a network. The messaging system 800 includes multiple instances of a client device 328 which host a number of applications, including a messaging client 802 and other applications 804. A messaging client 802 is communicatively coupled to other instances of the messaging client 802 (e.g., hosted on respective other client devices 328), a messaging server system 806 and third-party servers 808 via a network 330 (e.g., the Internet). A messaging client 802 can also communicate with locally-hosted applications 804 using Applications Program Interfaces (APIs).

A messaging client 802 is able to communicate and exchange data with other messaging clients 802 and with the messaging server system 806 via the network 330. The data exchanged between messaging clients 802, and between a messaging client 802 and the messaging server system 806, includes functions (e.g., commands to invoke functions) as well as payload data (e.g., text, audio, video or other multimedia data).

The messaging server system 806 provides server-side functionality via the network 330 to a particular messaging client 802. While some functions of the messaging system 800 are described herein as being performed by either a messaging client 802 or by the messaging server system 806, the location of some functionality either within the messaging client 802 or the messaging server system 806 may be a design choice. For example, it may be technically preferable to initially deploy some technology and functionality within the messaging server system 806 but to later migrate this technology and functionality to the messaging client 802 where a client device 328 has sufficient processing capacity.

The messaging server system 806 supports various services and operations that are provided to the messaging client 802. Such operations include transmitting data to, receiving data from, and processing data generated by the messaging client 802. This data may include message content, client device information, geolocation information, media augmentation and overlays, message content persistence conditions, social network information, and live event information, as examples. Data exchanges within the messaging system 800 are invoked and controlled through functions available via user interfaces (UIs) of the messaging client 802.

Turning now specifically to the messaging server system 806, an Application Program Interface (API) server 810 is coupled to, and provides a programmatic interface to, application servers 814. The application servers 814 are communicatively coupled to a database server 816, which facilitates access to a database 820 that stores data associated with messages processed by the application servers 814. Similarly, a web server 824 is coupled to the application servers 814, and provides web-based interfaces to the application servers 814. To this end, the web server 824 processes incoming network requests over the Hypertext Transfer Protocol (HTTP) and several other related protocols.

The Application Program Interface (API) server 810 receives and transmits message data (e.g., commands and message payloads) between the client device 328 and the application servers 814. Specifically, the Application Program Interface (API) server 810 provides a set of interfaces (e.g., routines and protocols) that can be called or queried by the messaging client 802 in order to invoke functionality of the application servers 814. The Application Program Interface (API) server 810 exposes various functions supported by the application servers 814, including account registration, login functionality, the sending of messages, via the application servers 814, from a particular messaging client 802 to another messaging client 802, the sending of media files (e.g., images or video) from a messaging client 802 to a messaging server 812, and for possible access by another messaging client 802, the settings of a collection of media data (e.g., story), the retrieval of a list of friends of a user of a client device 328, the retrieval of such collections, the retrieval of messages and content, the addition and deletion of entities (e.g., friends) to an entity graph (e.g., a social graph), the location of friends within a social graph, and opening an Application event (e.g., relating to the messaging client 802).

The application servers 814 host a number of server applications and subsystems, including for example a messaging server 812, an image processing server 818, and a social network server 822. The messaging server 812 implements a number of message processing technologies and functions, particularly related to the aggregation and other processing of content (e.g., textual and multimedia content) included in messages received from multiple instances of the messaging client 802. The text and media content from multiple sources may be aggregated into collections of content (e.g., called stories or galleries). These collections are then made available to the messaging client 802. Other processor and memory intensive processing of data may also be performed server-side by the messaging server 812, in view of the hardware requirements for such processing.

The application servers 814 also include an image processing server 818 that is dedicated to performing various image processing operations, typically with respect to images or video within the payload of a message sent from or received at the messaging server 812.

The social network server 822 supports various social networking functions and services and makes these functions and services available to the messaging server 812. To this end, the social network server 822 maintains and accesses an entity graph within the database 820. Examples of functions and services supported by the social network server 822 include the identification of other users of the messaging system 800 with which a particular user has relationships or is “following,” and also the identification of other entities and interests of a particular user.

The messaging client 802 can notify a user of the client device 328, or other users related to such a user (e.g., “friends”), of activity taking place in shared or shareable sessions. For example, the messaging client 802 can provide participants in a conversation (e.g., a chat session) in the messaging client 802 with notifications relating to the current or recent use of a game by one or more members of a group of users. One or more users can be invited to join in an active session or to launch a new session. In some examples, shared sessions can provide a shared augmented reality experience in which multiple people can collaborate or participate.

### Software Architecture

FIG. 9 is a block diagram 500 illustrating a software architecture 504, which can be installed on any one or more of the devices described herein. The software architecture 904 is supported by hardware such as a machine 902 that includes processors 920, memory 926, and I/O components 938. In this example, the software architecture 904 can be conceptualized as a stack of layers, where individual layers provides a particular functionality. The software architecture 904 includes layers such as an operating system 912, libraries 908, frameworks 910, and applications 906. Operationally, the applications 906 invoke API calls 950 through the software stack and receive messages 952 in response to the API calls 950.

The operating system 912 manages hardware resources and provides common services. The operating system 912 includes, for example, a kernel 914, services 916, and drivers 922. The kernel 914 acts as an abstraction layer between the hardware and the other software layers. For example, the kernel 914 provides memory management, processor management (e.g., scheduling), component management, networking, and security settings, among other functionalities. The services 916 can provide other common services for the other software layers. The drivers 922 are responsible for controlling or interfacing with the underlying hardware. For instance, the drivers 922 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

The libraries 908 provide a low-level common infrastructure used by the applications 906. The libraries 908 can include system libraries 918 (e.g., C standard library) that provide functions such as memory allocation functions, string manipulation functions, mathematic functions, and the like. In addition, the libraries 908 can include API libraries 924 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) graphic content on a display, GLMotif used to implement 3D user interfaces), image feature extraction libraries (e.g. OpenIMAJ), database libraries (e.g., SQLite to provide various relational database functions), web libraries (e.g., WebKit to provide web browsing functionality), and the like. The libraries 908 can also include a wide variety of other libraries 928 to provide many other APIs to the applications 906.

The frameworks 910 provide a high-level common infrastructure that is used by the applications 906. For example, the frameworks 910 provide various graphical user interface (GUI) functions, high-level resource management, and high-level location services. The frameworks 910 can provide a broad spectrum of other APIs that can be used by the applications 906, some of which may be specific to a particular operating system or platform.

In an example, the applications 906 may include a home application 936, a contacts application 930, a browser application 932, a book reader application 934, a location application 942, a media application 944, a messaging application 946, a game application 948, and a broad assortment of other Applications such as third-party applications 940. The applications 906 are programs that execute functions defined in the programs. Various programming languages can be employed to create one or more of the applications 906, structured in a variety of manners, such as object-oriented programming languages (e.g., Objective-C, Java, or C++) or procedural programming languages (e.g., C or assembly language). In a specific example, the third-party applications 940 (e.g., Applications developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party applications 940 can invoke the API calls 950 provided by the operating system 912 to facilitate functionality described herein.

### Machine Architecture

FIG. 10 is a diagrammatic representation of a machine 1000 within which instructions 1010 (e.g., software, a program, an application, an applet, an app, or other executable code) for causing the machine 1000 to perform any one or more of the methodologies discussed herein may be executed. For example, the instructions 1010 may cause the machine 1000 to execute any one or more of the methods described herein. The instructions 1010 transform the general, non-programmed machine 1000 into a particular machine 1000 programmed to carry out the described and illustrated functions in the manner described. The machine 1000 may operate as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a head-worn device (e.g., a smart watch), a smart home device (e.g., a smart appliance), other smart devices, a web appliance, a network router, a network switch, a network bridge, or any machine capable of executing the instructions 1010, sequentially or otherwise, that specify actions to be taken by the machine 1000. Further, while a single machine 1000 is illustrated, the term “machine” may also be taken to include a collection of machines that individually or jointly execute the instructions 1010 to perform any one or more of the methodologies discussed herein.

The machine 1000 may include processors 1002, memory 1004, and I/O components 1006, which may be configured to communicate with one another via a bus 1044. In an example, the processors 1002 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 1008 and a processor 1012 that execute the instructions 1010. The term “processor” is intended to include multi-core processors that may comprise two or more independent processors (sometimes referred to as “cores”) that may execute instructions contemporaneously. Although FIG. 10 shows multiple processors 1002, the machine 1000 may include a single processor with a single core, a single processor with multiple cores (e.g., a multi-core processor), multiple processors with a single core, multiple processors with multiples cores, or any combination thereof.

The memory 1004 includes a main memory 1014, a static memory 1016, and a storage unit 1018, both accessible to the processors 1002 via the bus 1044. The main memory 1004, the static memory 1016, and storage unit 1018 store the instructions 1010 embodying any one or more of the methodologies or functions described herein. The instructions 1010 may also reside, completely or partially, within the main memory 1014, within the static memory 1016, within machine-readable medium 1020 within the storage unit 1018, within one or more of the processors 1002 (e.g., within the processor's cache memory), or any suitable combination thereof, during execution thereof by the networked system 300.

The I/O components 1006 may include a wide variety of components to receive input, provide output, produce output, transmit information, exchange information, capture measurements, and so on. The specific I/O components 1006 that are included in a particular machine will depend on the type of machine. For example, portable machines such as mobile phones may include a touch input device or other such input mechanisms, while a headless server machine will likely not include such a touch input device. It will be appreciated that the I/O components 1006 may include many other components that are not shown in FIG. 10. In various examples, the I/O components 1006 may include output components 1028 and input components 1032. The output components 1028 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1032 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further examples, the I/O components 1006 may include biometric components 1034, motion components 1036, environmental components 1038, or position components 1040, among a wide array of other components. For example, the biometric components 1034 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1036 include acceleration sensor components (e.g., accelerometer), gravitation sensor components, rotation sensor components (e.g., gyroscope), and so forth. The environmental components 1038 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1040 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1006 further include communication components 1042 operable to couple the networked system 300 to a network 1022 or devices 1024 via a coupling 1030 and a coupling 1026, respectively. For example, the communication components 1042 may include a network interface component or another suitable device to interface with the network 1022. In further examples, the communication components 1042 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1024 may be another machine or any of a wide variety of peripheral devices (e.g., a peripheral device coupled via a USB).

Moreover, the communication components 1042 may detect identifiers or include components operable to detect identifiers. For example, the communication components 1042 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1042, such as location via Internet Protocol (IP) geolocation, location via Wi-Fi® signal triangulation, location via detecting an NFC beacon signal that may indicate a particular location, and so forth.

The various memories (e.g., memory 1004, main memory 1014, static memory 1016, and/or memory of the processors 1002) and/or storage unit 1018 may store one or more sets of instructions and data structures (e.g., software) embodying or used by any one or more of the methodologies or functions described herein. These instructions (e.g., the instructions 1010), when executed by processors 1002, cause various operations to implement the disclosed examples.

The instructions 1010 may be transmitted or received over the network 1022, using a transmission medium, via a network interface device (e.g., a network interface component included in the communication components 1042) and using any one of a number of well-known transfer protocols (e.g., hypertext transfer protocol (HTTP)). Similarly, the instructions 1010 may be transmitted or received using a transmission medium via the coupling 1026 (e.g., a peer-to-peer coupling) to the devices 1024.

A “carrier signal” refers to any intangible medium that is capable of storing, encoding, or carrying instructions for execution by the machine, and includes digital or analog communications signals or other intangible media to facilitate communication of such instructions. Instructions may be transmitted or received over a network using a transmission medium via a network interface device.

A “client device” refers to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

A “communication network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

A “component” refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing some operations and may be configured or arranged in a particular physical manner. In various examples, one or more computer systems (e.g., a standalone computer system, a client computer system, or a server computer system) or one or more hardware components of a computer system (e.g., a processor or a group of processors) may be configured by software (e.g., an Application or Application portion) as a hardware component that operates to perform some operations as described herein. A hardware component may also be implemented mechanically, electronically, or any suitable combination thereof. For example, a hardware component may include dedicated circuitry or logic that is permanently configured to perform some operations. A hardware component may be a special-purpose processor, such as a field-programmable gate array (FPGA) or an Application specific integrated circuit (ASIC). A hardware component may also include programmable logic or circuitry that is temporarily configured by software to perform some operations. For example, a hardware component may include software executed by a general-purpose processor or other programmable processor. Once configured by such software, hardware components become specific machines (or specific components of a machine) tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component”(or “hardware-implemented component”) is to be understood to encompass a tangible entity, be that an entity that is physically constructed, permanently configured (e.g., hardwired), or temporarily configured (e.g., programmed) to operate in a particular manner or to perform some operations described herein. Considering examples in which hardware components are temporarily configured (e.g., programmed), the hardware components may not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be partially processor-implemented, with a particular processor or processors being an example of hardware. For example, some of the operations of a method may be performed by one or more processors or processor-implemented components. Moreover, the one or more processors may also operate to support performance of the relevant operations in a “cloud computing” environment or as a “software as a service” (SaaS). For example, at some of the operations may be performed by a group of computers (as examples of machines including processors), with these operations being accessible via a network (e.g., the Internet) and via one or more appropriate interfaces (e.g., an API). The performance of some of the operations may be distributed among the processors, residing within a single machine as well as being deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

A “computer-readable medium” refers to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

A “machine-storage medium” refers to a single or multiple storage devices and/or media (e.g., a centralized or distributed database, and/or associated caches and servers) that store executable instructions, routines and/or data. The term includes, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at some of which are covered under the term “signal medium.”

A “processor” refers to any circuit or virtual circuit (a physical circuit emulated by logic executing on an actual processor) that manipulates data values according to control signals (e.g., “commands”, “op codes”, “machine code”, and so forth) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously.

A “signal medium” refers to any intangible medium that is capable of storing, encoding, or carrying the instructions for execution by a machine and includes digital or analog communications signals or other intangible media to facilitate communication of software or data. The term “signal medium” may be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

Changes and modifications may be made to the disclosed examples without departing from the scope of the present disclosure. These and other changes or modifications are intended to be included within the scope of the present disclosure, as expressed in the following claims.

1. A system comprising:
at least one processor;
at least one memory component storing instructions that, when executed by the at least one processor, cause the at least one processor to perform operations comprising:
receiving image data from one or more cameras of an augmented reality device;
detecting, using a computer vision model, a hand of a user within the image data;
causing one or more user interface elements to display on the hand of the user;
determining that the hand is holding a physical object for at least a predefined number of frames by analyzing the image data over multiple frames; and
based on determining that the hand is holding the physical object for at least the predefined number of frames, disabling the one or more user interface elements displayed on the hand that is holding the physical object so that the one or more user interface elements no longer appear on the hand that is holding the physical object.

2. The system of claim 1, wherein the computer vision model is a machine learning model trained to detect objects, such as a hand, in image data.

3. The system of claim 1, wherein the physical object is a phone-like object.

4. The system of claim 1, wherein the image data is analyzed over multiple frames using a machine learning model to determine that the hand is holding the physical object for at least the predefined number of frames.

5. The system of claim 4, wherein the machine learning model is trained on image data comprising images with at least one hand holding an object and images with one or more hands that are not holding an object, and hand-tracking data corresponding to the image data, the hand-tracking data indicating whether or not a hand is holding an object in a given image.

6. (canceled)

7. The system of claim 1, wherein one or more user interface elements comprise one or more virtual buttons displayed on the hand.

8. The system of claim 1, the operations further comprising:
maintaining display of at least one interface element corresponding to a hand of the user that is not holding an object.

9. The system of claim 1, the operations further comprising:
determining that the hand is no longer holding the physical object; and
causing the one or more user interface elements to display again on the hand that was previously holding the physical object.

10. (canceled)

11. A computer-implemented method comprising:
at least one processor;
at least one memory component storing instructions that, when executed by the at least one processor, cause the at least one processor to perform operations comprising:
receiving image data from one or more cameras of an augmented reality device;
detecting, using a computer vision model, a hand of a user within the image data;
causing one or more user interface elements to display on the hand of the user;
determining that the hand is holding a physical object for at least a predefined number of frames by analyzing the image data over multiple frames; and
based on determining that the hand is holding the physical object for at least the predefined number of frames, disabling the one or more user interface elements displayed on the hand that is holding the physical object so that the one or more user interface elements no longer appear on the hand that is holding the physical object.

12. The computer-implemented method of claim 11, wherein the computer vision model is a machine learning model trained to detect objects, such as a hand, in image data.

13. The computer-implemented method of claim 11, wherein the physical object is a phone-like object.

14. The computer-implemented method of claim 11, wherein the image data is analyzed over multiple frames using a machine learning model to determine that the hand is holding the physical object for at least a predefined number of frames.

15. The computer-implemented method of claim 14, wherein the machine learning model is trained on image data comprising images with at least one hand holding an object and images with one or more hands that are not holding an object, and hand-tracking data corresponding to the image data, the hand-tracking data indicating whether or not a hand is holding an object in a given image.

16. (canceled)

17. The computer-implemented method of claim 11, wherein one or more user interface elements comprise one or more virtual buttons displayed on the hand.

18. The computer-implemented method of claim 11, further comprising:
maintaining display of at least one interface element corresponding to a hand of the user that is not holding an object.

19. The computer-implemented method of claim 11, further comprising:
determining that the hand is no longer holding the physical object; and
causing the one or more user interface elements to display again on the hand that was previously holding the physical object.

20. A non-transitory computer-readable storage medium storing instructions that, when executed by at least one processor, cause the at least one processor to perform operations comprising:
receiving image data from one or more cameras of an augmented reality device;
detecting, using a computer vision model, a hand of a user within the image data;
causing one or more user interface elements to display on the hand of the user;
determining that the hand is holding a physical object for at least a predefined number of frames by analyzing the image data over multiple frames; and
based on determining that the hand is holding the physical object for at least the predefined number of frames, disabling the one or more user interface elements displayed on the hand that is holding the physical object so that the one or more user interface elements no longer appear on the hand that is holding the physical object.

21. The system of claim 1, further comprising:
determining that the hand that is holding the physical object for at least the predefined number of frames is associated with a cursor, wherein the cursor moves as the hand moves so that the hand itself controls the cursor;
disabling the cursor controlled by the hand by disabling targeting rays associated with the hand; and
enabling the cursor to be controlled by the physical object held by the hand by enabling targeting rays associated with the physical object.

22. (canceled)

23. The system of claim 1, further comprising:
setting a flag to indicate that the hand has been detected holding the physical object for at least the predefined number of frames.

24. The system of claim 5, wherein the image data is analyzed over multiple frames using a machine learning model to determine that the hand is holding the object for at least the predefined number of frames, and further comprising:
collecting images showing variations in lighting conditions, environmental contexts, hand sizes and positions, object types and colors, grid patterns and holding positions;
generating training data comprising the images collected that include images of hands holding various phone models with different form factors and colors;
automatically generating labels for the training data to generate labeled training data by synchronizing the hand-tracking data with corresponding image frames to label each image to indicate whether a hand is holding an object or not; and
training the machine learning model on the labeled training data.
